(19) United States
(12) Patent Application Publication
(10) Pub. No.: US 2004/0210574 A1
(43) Pub. Date: Oct. 21, 2004

(54) Supplier scorecard system

(76) Inventors: Amanda Aponte, Indian Trail, NC (US); Maria Daly, Charlotte, NC (US)

Correspondence Address: STEVEN B. PHILLIPS, MOORE & VAN ALLEN, 2200 WEST MAIN STREET, SUITE 800, DURHAM, NC, 27705, US

(21) Appl. No.: 10/814,397

(22) Filed: Mar. 31, 2004

Related U.S. Application Data
(60) Provisional application No. 60/459,483, filed on Apr. 1, 2003.

(51) Int. Cl. G06F 7/00

(52) U.S. Cl. 707/5

(57) ABSTRACT

Supplier scorecard system. A “scorecard” based system is provided for evaluation of suppliers or vendors. The system can be used as part of an RFP process. A scorecard or matrix is created that includes a plurality of descriptive items relative to potential suppliers. The descriptive items can be questions, characteristics, or the like, and can have item weights and be organized into a plurality of categories having category weights. Copies of the scorecard can be distributed and each item for each supplier can be assigned a raw numerical score and a confidence level. Responses based on the scorecard matrix are collected and consolidated to produce reports that facilitate the evaluation of potential suppliers.

### CROSS-REFERENCE TO RELATED APPLICATION

This application claims priority from co-pending, provisional patent application No. 60/459,483 filed Apr. 1, 2003 by the inventors hereof, the entire disclosure of which is incorporated herein by reference.

### CROSS-REFERENCE TO COMPUTER PROGRAM LISTING APPENDIX

A portion of the present disclosure is contained in a compact disc, computer program listing appendix. The compact disc contains an MS-DOS file entitled scorcard.txt created on Mar. 30, 2004, of approximately 757 kilobytes. The contents of this file are incorporated herein by reference. Any references to “the appendix” or the like in this specification refer to the file contained on the compact disc.

The contents of this file are subject to copyright protection. The copyright owner has no objection to the reproduction by anyone of the patent document or the appendix as it appears in the Patent and Trademark Office patent files or records, but does not waive any other copyright rights by virtue of this patent application.

### BACKGROUND OF INVENTION

Selecting the best vendor or supplier for a company or enterprise is of enormous importance and has a significant impact on the company's success in the marketplace. Despite this importance, it is often difficult to collect and present the characteristics of a group of potential suppliers in a way that facilitates objective evaluation in the course of a request for proposal (RFP) evaluation or similar activity. Sometimes data that attempts to do this is distributed around separate systems and lacks currency. In other cases the supplier selection process relies too heavily on the subjective judgment of management or other personnel. Comprehensive databases of RFP information can be created to assist, but it is often difficult to view the data in a meaningful way. Ideally, supplier evaluation processes that ultimately lead to supplier selection should be monitored and made as objective as possible, while still making use valuable personal insight and experience where appropriate.

### SUMMARY OF INVENTION

The present invention, as described in example embodiments, provides for a “scorecard” based system for evaluation of suppliers or vendors. The system can be used as part of an RFP process. The invention can provide weighting based on a double or two-weight system, which takes into account item weights for items or questions within a category as well as category weights. In example embodiments, both objective scores and subjective confidence in those scores can be consolidated in such a way as to provide reports that facilitate supplier evaluation.

A method according to some embodiments of the invention can include the creation of a scorecard or matrix that includes a plurality of descriptive items relative to potential suppliers. The descriptive items can be questions, characteristics, or the like, and can have item weights and be organized into a plurality of categories having category weights. Each item for each supplier can be assigned a raw numerical score by a scorer, evaluator, user or other party. In some embodiments, copies of the scorecard are distributed. Responses based on the scorecard matrix are collected from at least some of the plurality of scorers and consolidated to assign at least some of the plurality of suppliers weighted scores based at least in part on the raw numerical score, the category weights, and the items weights.

In at least some embodiments, the responses can include a confidence factor, which can be assigned to each of the plurality of descriptive items for each supplier. The confidence factor can provide a subjective indication of how much the objective score for an item or category should be relied on for a given supplier. In such a case, the consolidating of the responses may include producing average confidence factors for the suppliers. In some embodiments, the responses can further include an indication of critical items or “show stoppers” from among the descriptive items. Reports, graphs, charts, and the like, can be generated based at least in part on the weighted scores and possibly on the other factors, to allow viewing the data in such a way as to facilitate evaluating the suppliers.

In some embodiments, the invention is implemented via either a stand-alone computing platform or a computing platform with a network connection. A computer program product or computer program products contain computer programs with various instructions to cause the hardware to carry out, at least in part, the methods and processes of the invention. Data stores or a data warehouse can be connected to a computing platform. Dedicated software can be provided to implement the invention, or alternatively, a spreadsheet program with appropriate macros can be used to implement embodiments of the invention. In either case a user input screen is operable to receive appropriate input for creating the scorecards, and a processing platform can consolidate responses, and provide the necessary processing to store data and create the output needed for the evaluation.

### BRIEF DESCRIPTION OF DRAWINGS

FIG. 1 is a flowchart showing the process according to embodiments of the invention.

FIG. 2 is an additional flowchart showing some additional details of a process according to some embodiments of the invention.

FIG. 3 is a block diagram showing how reports and charts can be created from scorecard data according to some embodiments of the invention.

FIG. 4 is a screen shot illustrating the setting up of categories in order to create a scorecard matrix according to some embodiments of the invention.

FIG. 5 is a screen shot illustrating the setting up of descriptive items for a scorecard matrix according to some embodiments of the invention.

FIG. 6 is a screen shot illustrating additional details of setting up a supplier scorecard according to example embodiments of the invention.

FIG. 7 is an example screen shot of a scorecard scoring matrix according to some embodiments of the present invention.

FIG. 8 is a screen shot of a report screen according to some example embodiments of the invention.

FIG. 9 is an example chart that might be created by example embodiments of the invention.

FIG. 10 is a system diagram illustrating example operating environments according to embodiments of the invention.

### DETAILED DESCRIPTION

The present invention can most readily be understood by considering the detailed embodiments presented herein. Some of the embodiments are presented in the context of an enterprise using software to facilitate evaluation of suppliers as part of an RFP process. However, these embodiments are examples only. It cannot be overemphasized that the invention has applicability to any type or size of organization and can be used for any type of evaluation.

The present invention can be embodied in computer software or a computer program product. An embodiment may include a spreadsheet program and appropriate macro programs, algorithms, or plug-ins. An embodiment may also consist of a custom-authored software application for any of various computing platforms. One specific example discussed herein involves the use of a Windows™ personal computing platform running Microsoft Excel™ spreadsheet software, with appropriate Visual Basic™ macros. It cannot be overemphasized that this embodiment is an example only. The source code for example Visual Basic macros, which enable the invention to be implemented in such an example embodiment is included in the appendix. The source code example will be readily understood by those of ordinary skill in the art. It will also be readily understood that the inventive concepts described herein can be adapted to any type of hardware and software platform using any operating system including those based on Unix™ and Linux. In any such embodiments, the instruction execution or computing platform in combination with computer program code instructions form the means to carry out the processes of the invention.

It might facilitate the understanding of this description to know the meaning of some terms from the beginning. A “scorecard” or “scoring matrix” or, more simply, a “matrix” and the like can refer to either a physical scorecard, printed on paper, scorecard information or data stored in a computer system, or scorecards as defined by spreadsheet or similar program on a computer screen. A “descriptive item” is any item to which a score or rating can be assigned. Some descriptive items might be in the form of questions, such as “Can supplier provide electronic invoices?” but others may be a simple description or indication such as “Experience of supplier personnel.” A “raw numerical score” is a score as applied to an individual item without weighting. A “confidence factor” is a subjective numerical score that represents how much confidence an evaluator or user has in the objective score given an item, the objective score usually coming from a supplier's own information. Evaluators are often persons filling out and populating copies of a scorecard to facilitate evaluation of suppliers, but as will be discussed later, a scorer could be a supplier providing it's own information to the system. Other terms either have their ordinary and customary meaning or will be described when used or will be clear from context.

The process works as follows in an example implementation wherein an embodiment of the invention is used for supplier evaluation for an RFP. To create a scorecard, the RFP team works to determine the appropriate categories to use and their weighting. The team then determines which questions or other descriptive items are to be scored and what category each item falls under. The team can then determine the weight per question. Determining the weighting for both categories and items depends on the team's perspective as to what is most important in order to satisfy the business need. For example, if a particular RFP is being created in order to reduce costs for services used, then the pricing or cost category might carry the most weight. However, it will typically also be important that the service or goods being acquired be within certain specifications, so categories related to such concerns would normally have some weighting as well, but not as much in such a case as price. Thus, embodiments of the invention can provide the ability to determine categories and weightings based on a particular RFP's goals and objectives.

Once the items, categories, and weighting are determined, the scorecard is populated with this framework information. Copies of the scoring matrix, or “the scorecard” can then be downloaded and/or distributed and used by evaluators of the RFP scoring team, or others who are to populate the scorecards. Each team member scorer reviews the supplier RFP responses and scores/rates the RFP items individually with a raw numerical score on the scorecard. In example embodiments, this raw numerical score is on a 1-5 scale, although a system could be devised to make use of any scale. The individual scorecards are then turned in to be consolidated by a main scoring tool. This can be done over a network, manually, via media, etc. Once the tool is populated with each scorer's rating data, the tool runs through the calculation process. The tool takes the individual team member's scores and averages them. The tool then uses a double weighting process by taking the average score per item and multiplying it by the item weight. Then, the tool totals the scores of all question within a category and then multiplies that total score by the category weight to come up with the overall score for the category. Both weights within a category and weights of categories total 100%. After each category total is determined, the tool then calculates each supplier's overall score by adding the category scores together.

Note that although scorer's will typically be evaluators in an RFP process, a system can be devised in which suppliers themselves might enter scores if this can be done objectively. For example, there may be a desire or need to use a scorecard with purely objective questions, such as number of employees, whether a software product has a particular feature, or the like. Answers or scores for these items might be input over a network or from a data warehouse store, or the like.

In addition to scores, scorers or evaluators can also enter confidence factors in at least some embodiments of the invention. In one example embodiment, the confidence factor provides a subjective measure of how confident an evaluator or scorer is in the supplier's information which lead to or in fact is the raw numerical score for each item. On some example embodiments, the confidence factor carries a scale of 1-3 (Low, Med, High). This measures the evaluator's confidence on a particular supplier's response—does the evaluator really believe that the supplier can do what they say they can do within the RFP answer provided? Confidence factor data can be averaged across all answers, but is otherwise, in example embodiments, kept separate from objective scoring data, although it is stored and can be combined for reporting purposes. The confidence factor can provide an avenue to supplement objective information with valuable personal insight of team members where appropriate. In some embodiments, items can be flagged as critical items or “show stoppers.” Reporting can be made available with example embodiments of the invention to allow close examination of each element of the scoring so that a user can see not only the overall score per supplier, but also how each supplier compares per category, with the confidence factors, and the ultimate detail of rating per question per individual scorer.

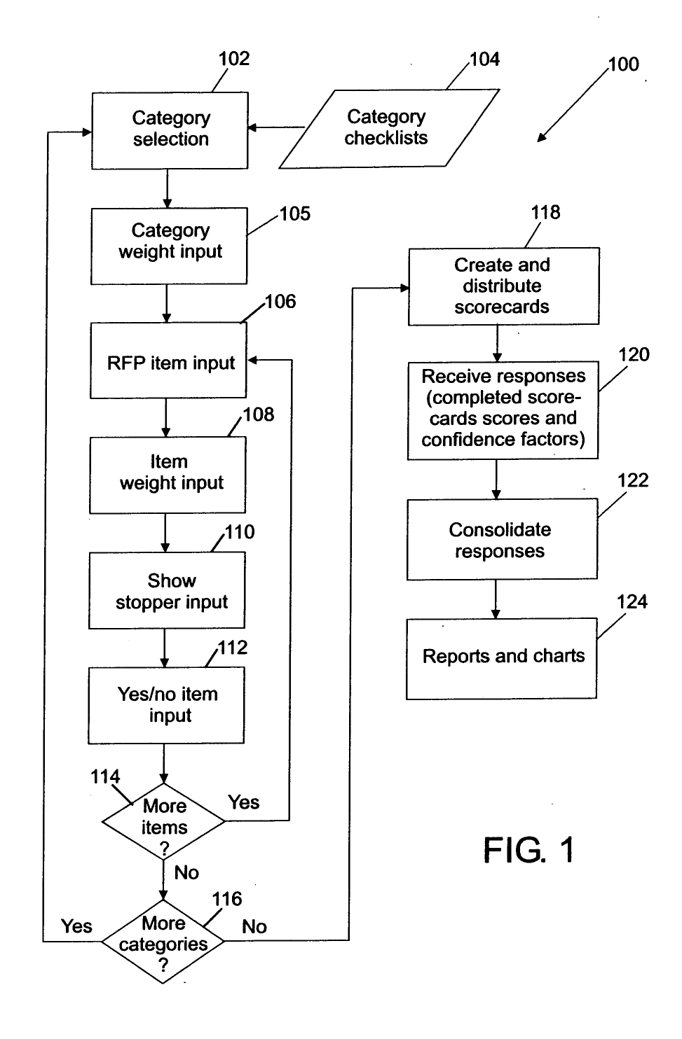

FIG. 1 is a flow chart illustration which shows how some embodiments of the invention operate in some environments. As is typical with flow charts, FIG. 1 illustrates process 100 of the invention as a series of process blocks. At block 102, category selection is carried out. This block typically involves user input, possibly from category checklist 104, which can be used by a team that is making use of an embodiment of the invention. At block 104 category weights are input. At block 106, various items are input for each category. In this example, it is assumed that an embodiment of the invention is being used for an RFP process. At block 108 each item is assigned a weight.

At block 110, items can be identified as “show stoppers” or items which are critical to the evaluation. In example software embodiments, this identification would be via a check block and the responses for such items could be highlighted in reports and graphs. At block 112, each item is provided with an indication as to whether it is a yes/no input item. Such items are assigned only two possible scores in the scoring process. By appropriately checking such an item, consistency between various scores is assured, and scorers are prevented from inputting raw numerical scores differently for a “yes” or a “no” across various copies of a scorecard.

At block 114 a check is made to determine if all the items have been input for a particular category. If there are more items, processing branches back to block 106. Otherwise, processing goes to block 116 for a determination as to whether there are more categories. If so, processing returns to the beginning of the process at block 102. Otherwise, the process continues to block 118 where the scorecards are created and distributed over a network or by other means.

At block 120, responses are received from the scorers or evaluators. In a typical embodiment, these can consist of completed scorecards and include both objective, raw, numerical scores, and confidence factors for each of the items in all of the categories. At block 122 all of the response data is consolidated by a tool implementing the invention, for example a spreadsheet program running appropriate macros. At block 124, reports and graphs can optionally be generated from this data. Such reports and graphs enable the data to be viewed conveniently, and facilitate the evaluation of the various suppliers or vendors.

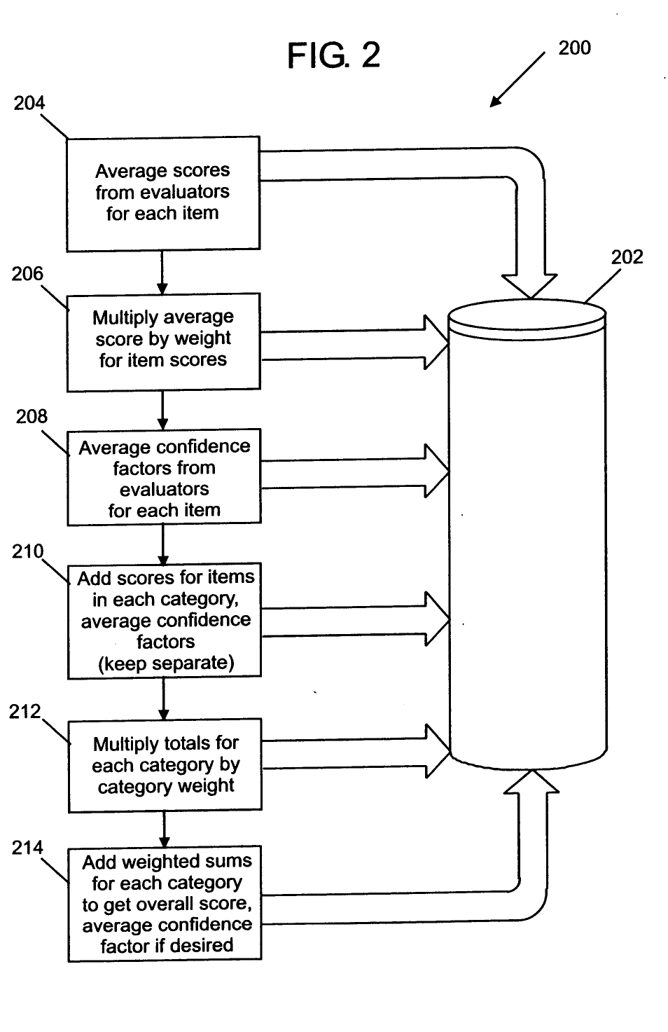

FIG. 2 is a flowchart which illustrates how the response data might be consolidated in some embodiments of the invention. Note in FIG. 2, a data store, 202, is provided to maintain a copy of all of the data that has been gathered. This data store can be provided via the storage capabilities of a workstation, server, or computing platform, as is known in the art. Thus, individual responses can be included in reports, as well as raw scores, confidence factors, averages, and any other type of information that can be calculated or retrieved and displayed based on the responses received. Thus, all of the blocks in the flowchart of FIG. 2 can input to data store 202. In many cases, these blocks also need to access data in the data store, however this can be assumed and such access paths are not shown for clarity.

At block 204 of process 200, scores from all of the evaluators are averaged for each item. At block 206, the average score for each item is multiplied by the weight for the item scores within a category. At block 208, confidence factors are averaged from all of the evaluators or scorers for each item. Note that both weighted item scores and separate confidence factor averages are written to data store 202.

Within a category, all of the scores are added at block 210. Confidence factors can also be averaged for a category. At block 212, the totals for each category are multiplied by the respective category weight. Finally, since it may be desirable to have an overall score for each supplier, the totals for all of the weighted category scores are added together to get an overall score at block 214. Likewise, an overall average confidence factor score can also be determined at block 214 and written to the data store which is maintaining all of the response data for the example RFP process.

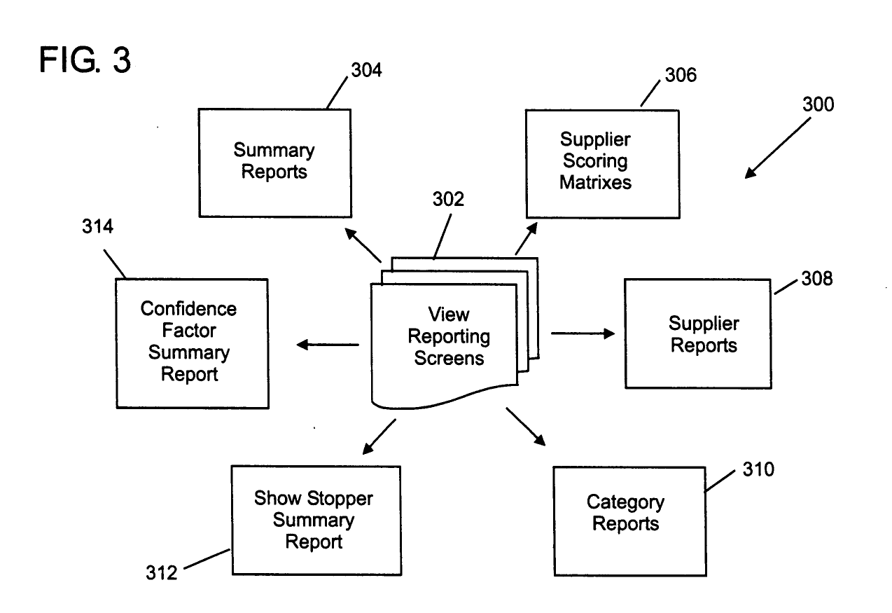

FIG. 3 is an example block diagram of a reporting system 300 which can generate various kinds of reports, charts, and graphs in accordance with embodiments of the invention. Various reporting screens 302 can be presented to a user, who can then direct the system, via user input to create various types of reports and graphs. In the example of FIG. 3, such reports include summary reports 304, supplier scoring matrices 306, supplier reports 308, category reports 310, show stopper summary reports 312, and confidence factor summary reports 314. One of ordinary skill in the art can easily devise numerous other types of reports that can be generated by an embodiment of the invention.

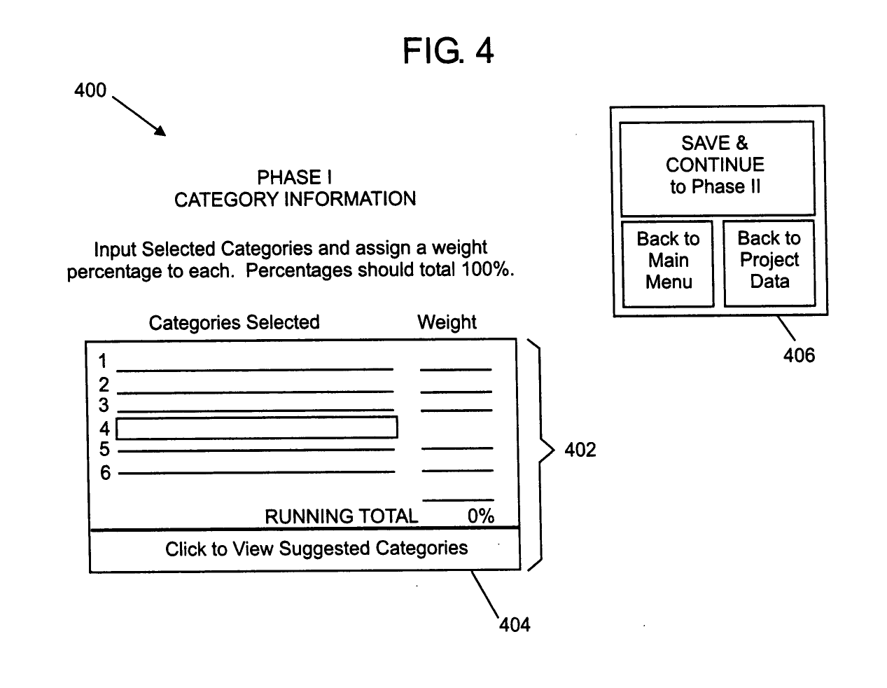

FIGS. 4-8 are screen shots of an example embodiment of the present invention. These screens depicted, or very similar screens are encountered when using the Visual Basic macros presented in the appendix of this application. They are presented to provide a convenient understanding of the operation of the invention while alleviating the necessity of actually reviewing the source code. In some cases, the screen shots have been simplified for clarity.

FIG. 4 illustrates a screen that might be encountered when setting up the various category information for an RFP process making use of an example embodiment of the invention. The category setup phase of the process might be referred to as “Phase I” herein. Screen 400 includes a section 402 where categories and their weights are listed. A running total is provided near the bottom of the category list to assist the user in establishing the weights so that they add up to 100%. Button 404 near the bottom of this section of the screen provides a list of suggested categories which are prestored in the system. Instructions near the top of the title section of the screen advise a user to “input selected categories and assign a weight percentage to each” and that “percentages should total 100%.” Button panel 406 provides a button to return back to the main menu, a button to return back to the project data, and a button to save the data and continue on to Phase II.

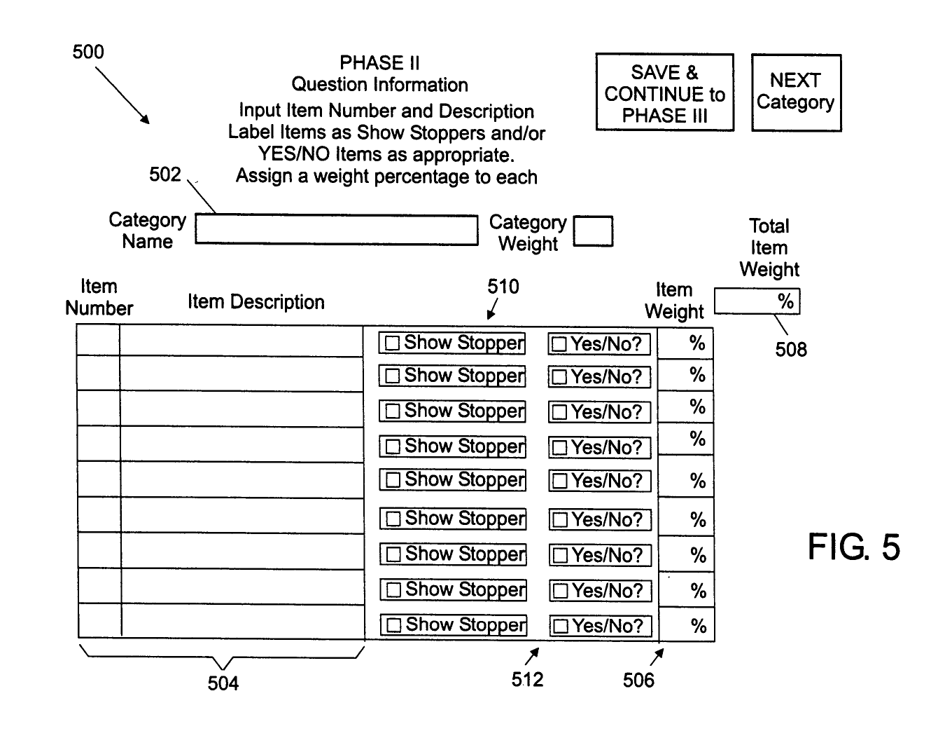

FIG. 5 shows an example screen 500 where question or item information can be gathered. The category name and weight are shown in boxes 502. Instructions at the top of the screen advise the user to “input number and description” and to “label items as show stoppers and yes/no items as appropriate.” The user is also asked to “assign a weight percentage to each item.” Each item number and its description are input in boxes 504. Weight percentages are input in boxes 506. A running total of the weight is indicated in box 508. Boxes 510 contain check blocks where a user can indicate when an item is a show stopper. Boxes 512 contain check blocks where a user can indicate whether an item is a yes/no item.

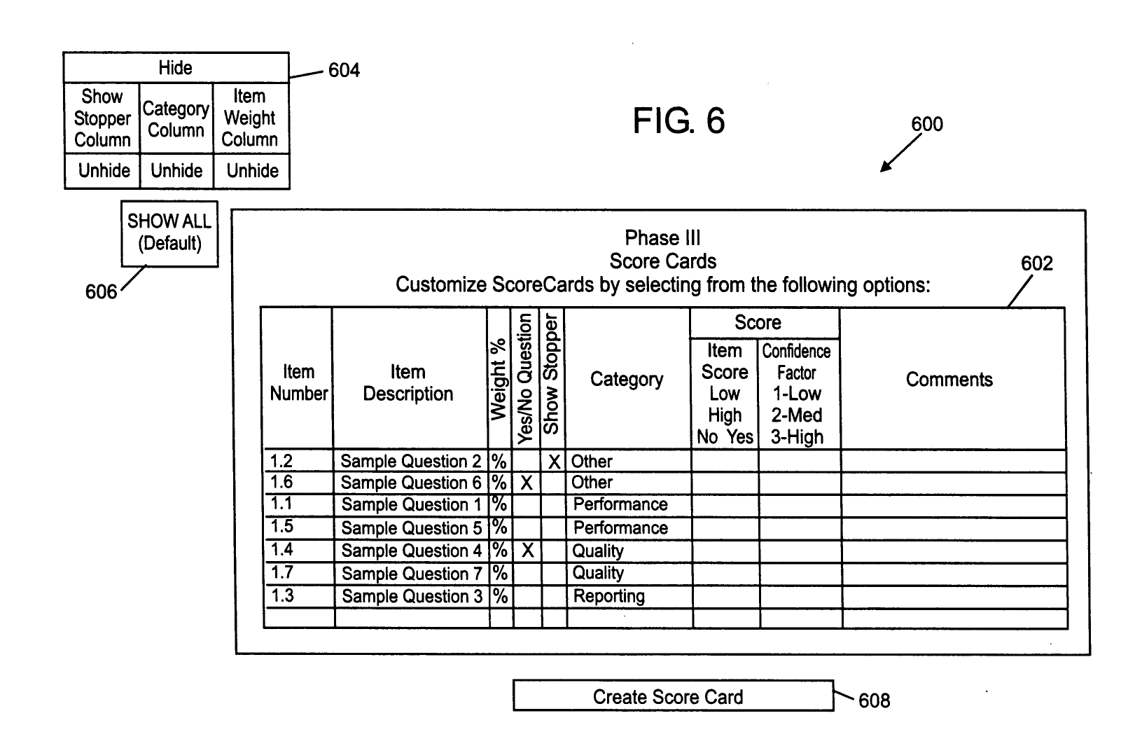

FIG. 6 is a setup screen for “Phase III” of the process, where scorecards can be previewed. Setup screen 600 includes preview pane 602 where scorecard data is previewed. Instructions at the top of the screen advise a user to “customize scorecards by selecting from the following options.” Button panel 604 provides a way for a user setting up a scorecard to hide the show stopper column, the category column, or the item weight column from scorers if desired to facilitate objectivity. Each column can also be unhidden with an “unhide” button. Button 606 unhides all columns. Finally, button 608 is used to finally create a scorecard according to embodiments of the invention.

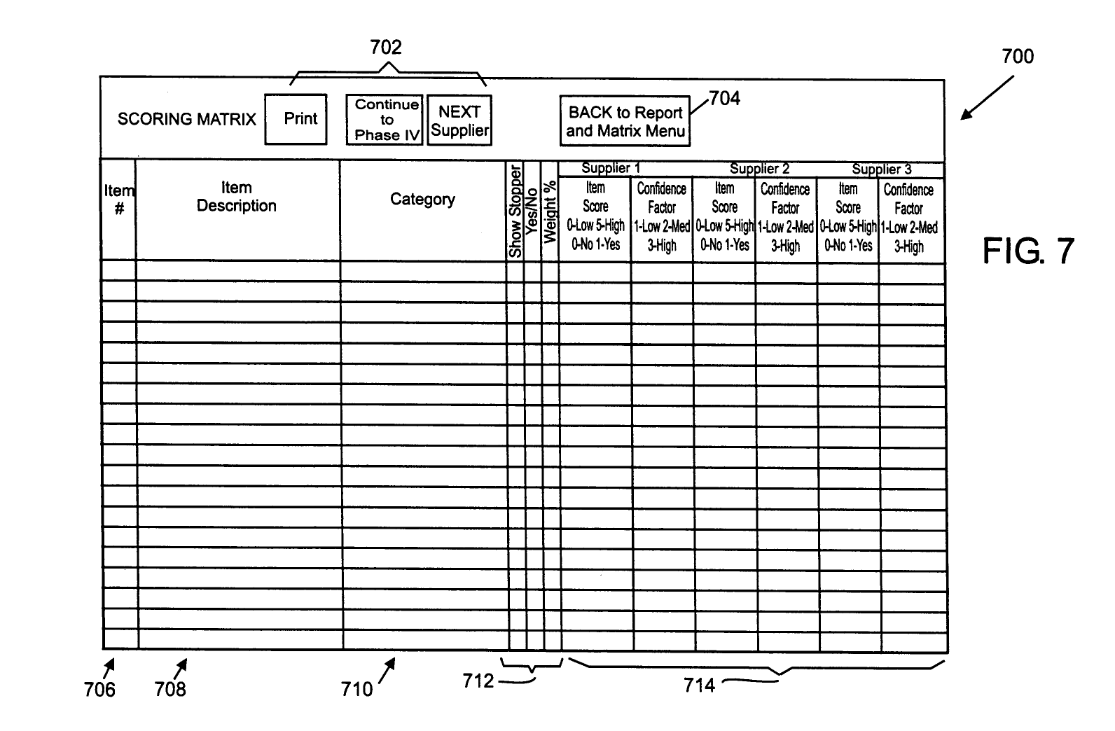

FIG. 7 illustrates a scoring matrix or scorecard 700 according to example embodiments of the invention. Button panel 702 near the top allows an evaluator or scorer to print, continue to Phase V, or move to the next supplier. The filling out of scorecard 700 is considered “Phase IV” in the example embodiment of the invention. Button 704 will take the user back to a report and matrix menu, which can be generated on scorer screens to give the scorers access to a distributed scorecard.

Column 706 contains the item number for the various items in this part of the scoring matrix. Column 708 contains an item description and column 710 contains item categories. Column 712 would contain checkmarks to highlight an item as a showstopper or as a yes/no item. In this particular example, the weight column is hidden. Columns 714 have the raw numerical scores and confidence factors for each item for the various suppliers.

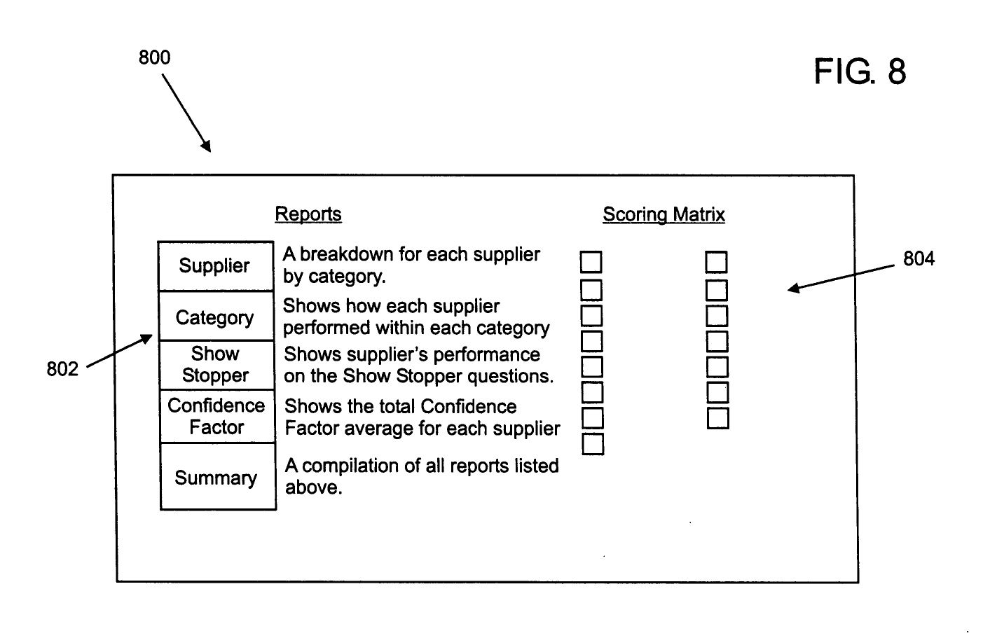

FIG. 8 illustrates a reporting screen, 800, according to this example embodiment of the invention. Reporting can be considered “Phase V” of the process in this example embodiment. A series of buttons, 802, along the left side of the screen are used to select various types of reports. A supplier report provides a breakdown for each supplier by category. A category report shows how each supplier performed within each category. A show stopper report shows a supplier's performance on show stopper items or questions. A confidence factor report shows the total confidence factor average for each supplier. A summary report is a compilation of all the above listed reports. The scoring matrix buttons, 804, on the right hand side of the screen match the number of specified suppliers and take the user back to the matrix level for viewing purposes for each supplier.

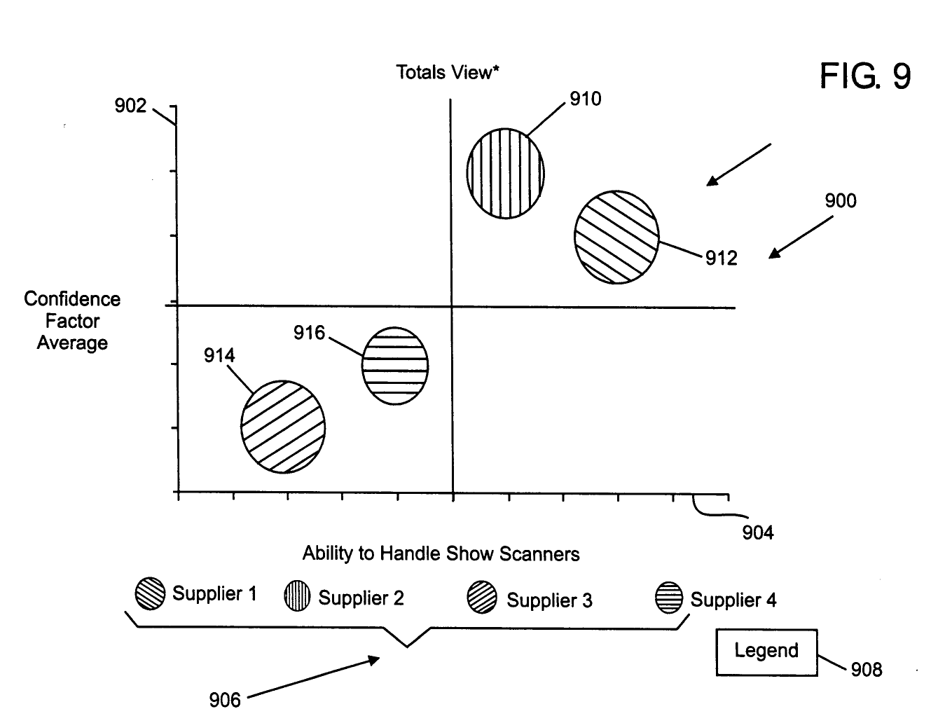

FIG. 9 illustrates one of many types of viewable and printable reports which can be generated with the example embodiment of the invention. FIG. 9 presents a bubble chart, 900, in which the confidence factor is presented on axis 902 and a score for supplier's ability to handle show stoppers is presented on axis 904. A key, 906, is provided to indicate which supplier corresponds to which color bubble. Although color is not shown in FIG. 9, the nature and operation of the chart of FIG. 9 can be readily understood. A button, 908, is provided to access a legend with additional detailed information about the suppliers and the data. In this example, the most desirable suppliers would be those located in the upper right-hand quadrant of the graph. Thus the supplier corresponding to bubble 910 and the supplier corresponding to bubble 912 would both be more desirable than the supplier corresponding to bubble 914 or the supplier corresponding to bubble 916.

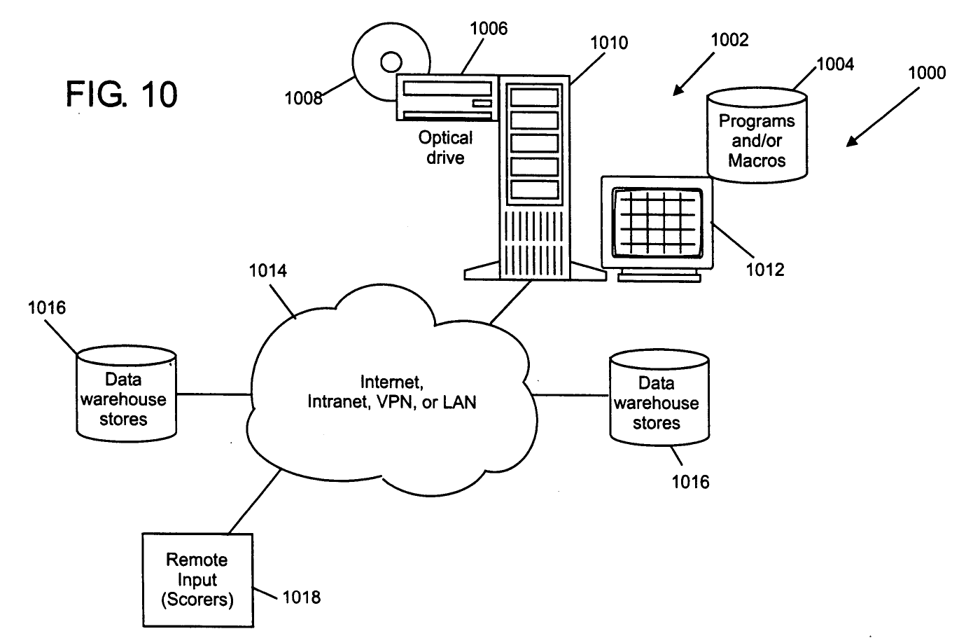

FIG. 10 illustrates a typical operating environment for embodiments of the present invention. FIG. 10 actually illustrates two alternative embodiments of a system implementing the invention. Computer system 1002 can be a workstation or personal computer. System 1002 can be operated in a “stand-alone” mode, in which a user enters all data including categories, weights, and items, as well as responses from scorers collected on paper or by other means. The system includes a fixed storage medium, illustrated graphically at 1004, for storing programs and/or macros which enable the use of an embodiment of the invention. In a spreadsheet implementation of the invention, these include the spreadsheet program and any macros or plug-ins, which are necessary to customize the spreadsheet program to implement an embodiment of the invention. Otherwise, these can include application programs or an application program, which implements the invention. In this particular example, an optical drive, 1006, is connected to the computing platform for loading the appropriate computer program product into system 1002 from an optical disk, 1008. The computer program product includes a computer program or programs with instructions for carrying out the methods of the invention.

Processing platform 1010 can execute the appropriate instructions and display appropriate screens on display device 1012. These screens can include a user input screen, reporting screens, etc. Files, tables, or sheets can be stored on storage medium 1004, or written out to an optical disk, such as optical disk 1008. In at least some spreadsheet implementations of the invention, display device 1012 displays a grid, which is commonly thought of as a “spreadsheet” and is illustrated in FIG. 10 as an example.

FIG. 10 also illustrates another embodiment of the invention in which case system 1000 which is implementing the invention can include either or both connections to a data warehouse or data warehouses which store supplier data, responses, etc. and/or connections to systems for remote input, such as desktop systems of scorers or even suppliers. Likewise, programs or macros that implement the invention, including a custom designed application, can be stored on storage medium 1004, and transported on optical disk 1008. The connection to the remote input system or data stores can be formed in part by network 1014, which can be an intranet, virtual private network (VPN) connection, local area network (LAN) connection, or any other type of network resources, including the Internet. Warehouse stores of supplier data may be part of one or more data stores or databases, 1016, and systems 1018 for remote input of responses, confidence factors, and the like are shown connected to the same network.

In any case, a computer program, which implements all or parts of the invention through the use of systems like those illustrated in FIG. 10, can take the form of a computer program product residing on a computer usable or computer readable storage medium. Such a computer program can be an entire application to perform all of the tasks necessary to carry out the invention, or it can be a macro or plug-in which works with an existing general purpose application such as a spreadsheet program. Note that the “medium” may also be a stream of information being retrieved when a processing platform or execution system downloads the computer program instructions through the Internet or any other type of network. Computer program instructions which implement the invention can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

The appendix to this application includes Visual Basic source code for a collection of macros, which work with the well-known Microsoft Excel spreadsheet program. The source code can be used by one of skill in the art to cause a computer system implementing Microsoft Excel to carry out the methods and processes of an example embodiment of the invention. The macros consist of code which implements a user input screen and other routines, which are used throughout the various stages of executing an embodiment of the invention. It cannot be over-emphasized that the exact implementation implicated by the appendix to this application is but an example. One of ordinary skill in the art can easily adapt the principles learned from studying the source code to other systems, dedicated applications, and even other computing platforms which do not make use of Microsoft Excel or any other spreadsheet program.

Specific embodiments of an invention are described herein. One of ordinary skill in the computing and statistical arts will recognize that the invention can be applied in other environments and in other ways. It should also be understood that not all of the elements and features in the drawings, or even in any one drawing are necessary to implement the invention as contemplated by any of the appended claims. Likewise, an implementation of the invention can include features and elements or steps in addition to those described and claimed herein. Also, the steps in the appended claims are not necessarily conducted in the order recited, and in fact, can be conducted in parallel in some cases. Thus, the following claims are not intended to limit the scope of the invention to the specific embodiments described herein.

1. A method of facilitating comparative evaluation of a plurality of potential suppliers, the method comprising:
creating a scorecard further comprising a plurality of descriptive items relative to the potential suppliers, the descriptive items having item weights organized into a plurality of categories having category weights, wherein each descriptive item can be assigned a raw numerical score by a scorer;
distributing the scorecard to a plurality of evaluators;
collecting responses from at least some of the plurality of evaluators, the responses comprising the raw numerical score for at least some of the plurality of descriptive items; and
consolidating the responses to assign at least some of the plurality of suppliers weighted scores based at least in part on the raw numerical score, the category weights, and the items weights for the at least some of the plurality of suppliers.

2. The method of claim 1 wherein the responses further comprise a confidence factor which can be assigned to each of the plurality of descriptive items, and wherein the consolidating of the responses further comprises producing average confidence factors for at least some of the plurality of suppliers.

3. The method of claim 2 wherein the responses further comprise an indication of critical items from among the descriptive items.

4. The method of claim 1 further comprising generating at least one report based at least in part on the weighted scores.

5. The method of claim 2 further comprising generating at least one report based at least in part on the weighted scores and the average confidence factors.

6. The method of claim 3 further comprising generating at least one report based at least in part on the weighted scores, the average confidence factors, and the indication of critical items.

7. A computer program product comprising a computer program for facilitating comparative evaluation of a plurality of potential suppliers, the computer program further comprising:
instructions for creating a scorecard further comprising a plurality of descriptive items relative to the potential suppliers, the descriptive items having item weights organized into a plurality of categories having category weights, wherein each descriptive item can be assigned a raw numerical score by a scorer;
instructions for consolidating responses from a plurality of evaluators based on the scorecard, the responses comprising the raw numerical score for at least some of the plurality of descriptive items, to assign at least some of the plurality of suppliers weighted scores based at least in part on the raw numerical score, the category weights, and the items weights for the at least some of the plurality of suppliers; and
instructions for generating at least one report based at least in part on the weighted scores.

8. The computer program product of claim 7 wherein the responses further comprise a confidence factor which can be assigned to each of the plurality of descriptive items, and wherein the instructions for consolidating further comprise instructions for producing average confidence factors for at least some of the plurality of suppliers.

9. The computer program product of claim 7 wherein the responses further comprise an indication of critical items from among the descriptive items.

10. The computer program product of claim 8 wherein the responses further comprise an indication of critical items from among the descriptive items.

11. Apparatus for facilitating comparative evaluation of a plurality of potential suppliers, the apparatus comprising:
means for creating a scorecard further comprising a plurality of descriptive items relative to the potential suppliers, the descriptive items having item weights organized into a plurality of categories having category weights, wherein each descriptive item can be assigned a raw numerical score by a scorer;
means for consolidating responses from a plurality of evaluators based on the scorecard, the responses comprising the raw numerical score for at least some of the plurality of descriptive items, to assign at least some of the plurality of suppliers weighted scores based at least in part on the raw numerical score, the category weights, and the items weights for the at least some of the plurality of suppliers; and
means for generating at least one report based at least in part on the weighted scores.

12. The apparatus of claim 11 wherein the responses further comprise a confidence factor which can be assigned to each of the plurality of descriptive items, and further comprising means for producing average confidence factors for at least some of the plurality of suppliers.

13. The apparatus of claim 11 wherein the responses further comprise an indication of critical items from among the descriptive items.

14. The apparatus of claim 12 wherein the responses further comprise an indication of critical items from among the descriptive items.

15. A system operable to generate reports to facilitate comparative evaluation of a plurality of potential suppliers, the system comprising:
a user input screen operable to receive as input, information for creating a scorecard further comprising a plurality of descriptive items relative to the potential suppliers, the descriptive items having item weights organized into a plurality of categories having category weights, wherein each descriptive item can be assigned a raw numerical score;
functionality to collect responses comprising the raw numerical score for at least some of the plurality of descriptive items; and
a processing platform operable to consolidate responses based on the scorecard, the responses comprising the raw numerical score for at least some of the plurality of descriptive items, and to assign at least some of the plurality of suppliers weighted scores based at least in part on the raw numerical score, the category weights, and the items weights for the at least some of the plurality of suppliers.

16. The system of claim 15 wherein the processing platform is further operable to produce average confidence factors to at least some of the plurality of suppliers based on confidence factors assigned for at least some of each of the plurality of descriptive items.

17. The system of claim 15 wherein the responses can include an indication of critical items from among the descriptive items.

18. The system of claim 15 further comprising a network connection to collect the responses.

19. The system of claim 16 further comprising a network connection to collect the responses.

20. The system of claim 17 further comprising a network connection to collect the responses.
